(19) United States
(12) Patent Application Publication
(10) Pub. No.: US 2009/0195548 A1
(43) Pub. Date: Aug. 6, 2009

(54) Method and Apparatus for Improved Display of Digital Mammographic Images

(75) Inventors: Peter Heinlein, Munchen (DE); Wilfried Schneider, Wittenbeck (DE); Marco Blumenthal, Jena (DE)

Correspondence Address: PETER VOGEL;GE HEALTHCARE, 20225 WATER TOWER BLVD., MAIL STOP W492, BROOKFIELD, WI, 53045, US

(73) Assignee: General Electric Company, Schenectady, NY (US)

(21) Appl. No.: 12/276,407

(22) Filed: Nov. 23, 2008

(30) Foreign Application Priority Data
Nov. 23, 2007 (DE) 102007057015.7

(51) Int. Cl. G09G 5/02; G06T 1/00; G06T 11/20; G09G 5/00

(52) U.S. Cl. 345/589; 345/418; 345/443; 345/672; 345/666

(57) ABSTRACT

A method and apparatus for improved display of digital mammographic images, which include at least two mammograms that represent different orientation views on a display. It is intended that a place on a mammographic image of a first orientation view and a correspondence strip (4) on a mammographic image of a second orientation view is determined. The correspondence strip indicates a range in the mammographic image of the second orientation view in which the place of the mammographic image of a first orientation view may be located. The method and apparatus are made available for the improved display of digital mammograms, which the display of the mammograms may be improved in way that is intuitive for a user in such a way that the review of mammograms is made easier.

### CROSS-REFERENCE TO RELATED APPLICATIONS

This application claims the benefit of a priority under 35 U.S.C. 119(a)-(d) to German Patent Application No. 102007057015.7, filed Nov. 23, 2007, the entire contents of which are hereby incorporated by reference.

### BACKGROUND OF THE INVENTION

This disclosure relates generally to a method and apparatus for improved display of digital mammographic images.

Digital mammographic images or mammograms are usually presented as gray scale images having individual pixels, with each pixel having a pixel value corresponding to a specific gray scale value. These gray scale values may lie within 8 range of values between a minimum value of, for example, 0 (black) and a maximum value of, for example, 225 (white). The edge length of a typical mammogram is approximately 2000 to 4000 pixels, and the dissolution of a typical mammogram is approximately 10 line pairs/mm and/or 0.1 mm/pixel.

A mammographic imaging system may be coupled to a workstation, for example, a PACS (Picture Archiving and Communication System) workstation, on which a mammogram may be viewed and reviewed by a physician or other medical professional. Mammography assigned PACS workstations usually have high resolution monitors, which are able to represent the high volume range and the comparatively high resolution of mammographic images.

Mammographic imaging systems generate raw mammograms containing measured data. These raw mammograms exhibit a global image characteristics with a comparatively high contrast in a boundary region of the measured object (i.e., the boundary region of the breast) and a relatively low contrast inside the measured object (i.e., the inside the breast). Conventional PACS workstations typically include tools for selecting parts of the whole gray scale level range and displaying these parts with maximum contrast through window level settings. Gray scale level ranges outside of the selected gray scale level window are mapped to the smallest or highest possible gray scale level, which means that information contained in these outside ranges is no longer displayed. Alternatively, nonlinear transfer functions represented through so called lookup tables may be applied to the raw mammogram modifying the global image characteristics in order to achieve a better over-all-contrast. Since the available total range of gray scale levels is fixed, a contrast enhancement for a selected part of the gray scale level range leads to a decrease of contrast in other gray level ranges. Therefore, an optimal display of all gray scale levels of the mammogram with optimal contrast and sharpness cannot be achieved by applying window level settings and/or lookup tables.

A mammography exam typically involves taking two images having different orientations or views of the breast, one from above, a cranio-claudal (CC) view and one from an oblique or angled view, a mediolateral-oblique (MLO) view.

A problem with reviewing mammograms of different orientations (e.g., CC or MLO views) is that there is not an intuitive way for a physician or other medical professional to easily recognize spatial orientations or finding relationships between the images. This problem may occur especially when reviewing CC and MLO views side-by-side on a workstation monitor. This may lead to problems in reviewing the mammograms and potentially cause errors in a diagnosis.

Therefore, there is a need for a method and apparatus for an intuitive way for a physician or other medical professional to easily recognize spatial orientations or finding relationships between the images of different views or orientations.

### BRIEF DESCRIPTION OF THE INVENTION

In accordance with an aspect of the disclosure, a method for displaying a digital mammographic image comprising obtaining a mammographic image using at least two different orientation views; determining and displaying a place in the mammographic image of a first orientation view; and determining and displaying a correspondence strip in the mammographic image of a second orientation view; wherein the correspondence strip indicates a range in the mammographic image of the second orientation view where to locate the place in the mammographic image of the second orientation view.

In accordance with an aspect of the disclosure, an apparatus for displaying a digital mammographic image comprising means for obtaining a mammographic image using at least two different orientation views; means for displaying a place in the mammographic image of a first orientation view; and means for displaying a correspondence strip in the mammographic image of a second orientation view; wherein the correspondence strip indicates a range in the mammographic image of the second orientation view where to locate the place in the mammographic image of the second orientation view.

Various other features, aspects, and advantages will be made apparent to those skilled in the art from the accompanying drawings and detailed description thereof.

### BRIEF DESCRIPTION OF THE DRAWINGS

FIG. 1 is a schematic representation of a display of a mammogram oriented in a cranio-claudal (CC) view and oriented in a mediolateral-oblique (MLO) view;

FIG. 2 is a schematic representation of a display of a mammogram oriented in a CC view and oriented in a MLO view; and

FIG. 3 is a schematic representation of a display of a mammogram oriented in a CC view and oriented in a MLO view.

### DETAILED DESCRIPTION OF THE INVENTION

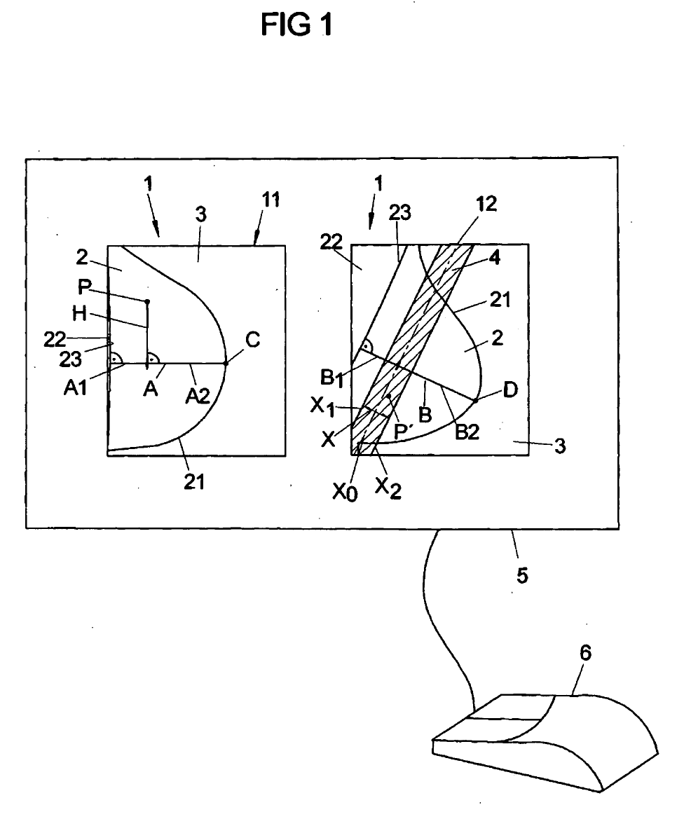

Referring now to the drawings, FIG. 1 illustrates a schematic representation of a display of a mammogram 1 oriented in a CC view 11 and the same mammogram oriented in a MLO view 12. Both mammogram views are of the same breast.

FIG. 1 shows a display 5, which may be part of a reviewing workstation for reviewing mammogram 1. The mammogram 1 includes an image of a breast 2 and a background 3. The mammogram 1 was taken and is displayed in two different orientations or views. The mammogram 1 is oriented in a CC view 11, and is oriented in a MLO view 12 on the same display 5 at the same time. The intent of the disclosure is to provide symmetry comparisons between the CC 11 and MLO 12 views.

It is often preferable to have four mammogram views on a display at once, two different views or orientations for each breast. For simplicity reasons, the drawings in FIGS. 1-3 only show two different views.

When reviewing a mammogram, a physician or other medical professional looks for suspicious areas that may show polyps, tumors or other abnormalities in a breast. When finding a suspicious area in a first view 11, it is not always east to find the same suspicious area in a second view 12.

In order to facilitate reviews of mammograms by a physician or other medical professional, a correspondence strip 4 is assigned in the second mammogram view 12 to help locate a place P in the first mammogram view 11. The correspondence strip 4 indicates a range in the second mammogram view 12 where the place P in the first mammogram view 11 may be located in the second mammogram view 12. Thus by displaying the correspondence strip 4, it indicates to the physician or other medical professional, in which range a place P in the first mammogram view 11 is located in the second mammogram view 12.

For example, the place P′ in the second mammogram view 12 lies within the correspondence strip 4 corresponding to the place P in the first mammogram view. The physician or other medical professional will not exclude place P′ due to the information, which he/she receives with correspondence strip 4.

The method for representation of the correspondence strip 4 proceeds from the knowledge of outline lines 21, 23 of the breast 2 and the musculus pectoralis 22 represented in the mammogram views. The outline lines 21, 23 may be determined for example with a procedure, as described in German Patent No. DE 102006021042. This procedure takes advantage of the structures of the breast 2 represented in both views 11, 12. These structures including the breast 2 and the musculus pectoralis 22.

For determining the correspondence strip 4, in the first mammogram view 11 a baseline A is drawn perpendicular from outline line 23 of the musculus pectoralis 22 to the outline line 21 at the furthest point C on outline line 21 of the breast 2. In the first mammogram view 11 a height H is drawn perpendicular to baseline A to the place P, which divides the baseline A into two sections A1 and A2.

In the second mammogram view 12, a baseline B is drawn perpendicular from outline line 23 of the musculus pectoralis 22 to the outline line 21 at the furthest point D on outline line 21 of the breast 2.

From geometric conditions of the mammogram views 11, 12, the baseline B of the second mammogram view 12 lies in approximately the same projection level as baseline A of the first mammogram view 11 (perpendicularly to the indication level of the first mammogram view 11 extended) and in reverse.

The baseline B of the second mammogram view 12 is divided into two sections B1, B2. The relationship B1 to B2 in the first mammogram view 11 corresponds to the relationship A1 to A2 in the second mammogram view 12. At the interconnect point of the two sections B1, B2 a center line X0 is drawn perpendicular to the baseline B, which defines the central line of the correspondence strip 4. Symmetrically around the center line X0 are surfacing edge lines X1, X2 as lateral border lines of the correspondence strip 4. The distance between X1 and X2 corresponds to a tenth of the length of the baseline B and thus defines the width X of the correspondence strip 4.

The correspondence strip 4 indicates a tolerance interval as the width X, within where the place P can lie within the second mammogram view 12. The width X is determined empirically and arises from the boundary conditions in the case of the different mammogram views 11, 12, with which the breast 2 may be for example differently deformed dependent on the situation with the exam or orientation of the exposure.

The place P is defined in the first mammogram view 11 over an input device 6. By means of the input device 6 the place P can be shifted, whereby synchronously the correspondence strip 4 in the second mammogram view 12 is adapted accordingly.

Also, a place in the second mammogram view 12 may be selected, to which a correspondence strip in the first mammogram view 11 is then assigned.

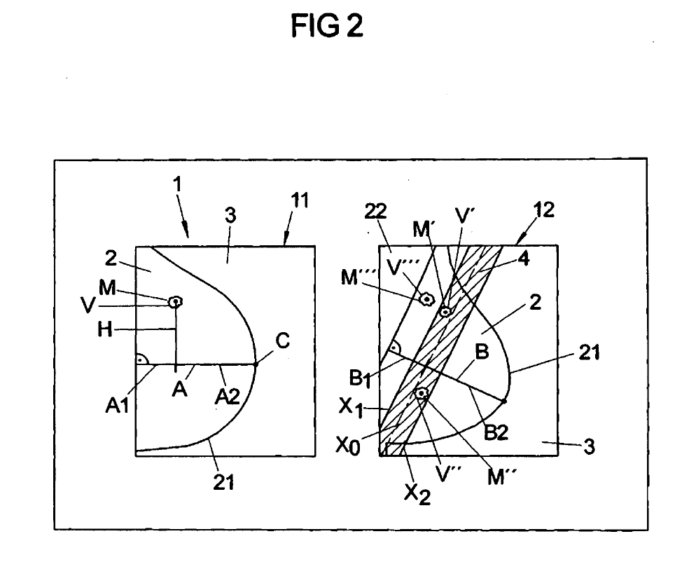

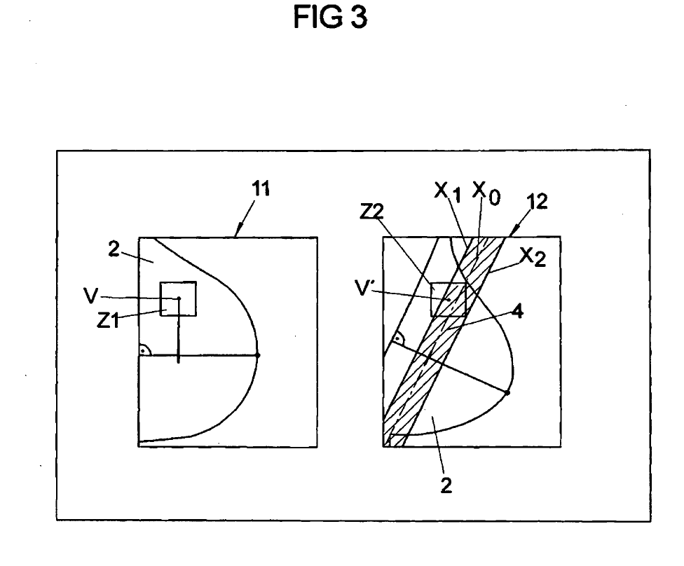

FIGS. 2 and 3 illustrate further application possibilities of the correspondence strip 4, which go beyond the pure representation.

FIG. 2 illustrates a schematic representation of a display of a mammogram 1 oriented in a CC view 11 and oriented in a MLO view 12. In FIG. 2 a suspicious area V is marked with a marker M in the first mammogram view 11. The first mammogram view 11 having a suspicious area V marked by a marker M for correspondence in the correspondence strip 4 in the second mammogram view 12.

By means of the correspondence strip 4, V′ may be assigned to the suspicious area V in the first mammogram view 11. Possible other suspicious areas V″ and V′″ marked by markers M″ and M′″ in the second mammogram view 12 may possibly correspond to the suspicious area V in the first mammogram view 11. When assigned suspicious areas V′, V″ all such suspicious areas are applicable, which lie within the correspondence strip 4. Accordingly, the suspicious areas V′, V″ may be marked by markers M′, M″. At the same time suspicious area V′″, which does not correspond due to its situation outside of the correspondence strip 4 with the suspicious area V in the first mammogram view 11, when not being applicable are excluded and marked if necessary separately by a marker M′″.

FIG. 3 illustrates a schematic representation of a display of a mammogram 1 oriented in a CC view 11 and oriented in a MLO view 12. In FIG. 3 an arrangement is represented with which by the allocation of a suspicious area V in the first mammogram to a suspicious area V′ in the second mammogram view 12 a synchronously increased representation of the regions Z1, Z2 of the suspicious area V in the first mammogram view 11 and the suspicious area V′ is made possible for in the second mammogram view 12. By a selection or input on the input device 6 on the suspicious area V in the first mammogram view 11 by means of the input device 6 thereby the region Z1 is increased at the same time around the suspicious area V and also the region Z2 around the suspicious area V′ in the second mammogram 12.

If a clear allocation of suspicious areas V is not possible in the first mammogram view 11 and the second mammogram view 12, for example because several suspicious areas are in question within the correspondence strip 4, then it is conceivable that the regions of all being applicable of suspicious areas in the second mammogram view 12 are increased or the users can select a suspicious area it wants to in the second mammogram view is increased. Conceivably it may also be used to indicate that the entire range of the breast 2 within the correspondence strip 4 is increased.

While the disclosure has been described with reference to various embodiments, those skilled in the art will appreciate that certain substitutions, alterations and omissions may be made to the embodiments without departing from the spirit of the disclosure. In particular the descriptive method and apparatus may be used with other mammogram orientations or views. It provides a simple and intuitive way for a physician or other medical professional to review mammograms of different orientations. This is reached by representation of a correspondence range in the form of a correspondence strip, which two or more sets of mammogram views with one another in relationship. Accordingly, the foregoing description is meant to be exemplary only, and should not limit the scope of the disclosure as set forth in the following claims.

1. A method for displaying digital mammographic images comprising:
obtaining a first mammographic image of a first orientation;
obtaining a second mammographic image of a second orientation;
determining and displaying a place in the first mammographic image of the first orientation; and
determining and displaying a correspondence strip in the second mammographic image of the second orientation;
wherein the correspondence strip indicates a range in the second mammographic image of the second orientation where to locate the place in the second mammographic image of the second orientation.

2. The method of claim 1, wherein the first and the second mammographic images are a cranio-claudal (CC) image and a mediolateral-oblique (MLO) image.

3. The method of claim 1, wherein determining the correspondence strip for each mammographic image orientation includes identifying an outline line of a breast in the mammographic image and an outline line of a musculus pectoralis in the mammographic image.

4. The method of claim 3, further comprising displaying a baseline perpendicular from the outline line of the musculus pectoralis to the outline line at a furthest point on the outline line of the breast.

5. The method of claim 1, further comprising displaying a height perpendicular to the baseline to the place, which divides the baseline into two sections in the first mammographic image.

6. The method of claim 5, further comprising:
displaying surfacing edge lines of the correspondence strip parallel to the outline line of the musculus pectoralis and perpendicular to the baseline in the second mammographic image; and
displaying a center line of the correspondence strip parallel to the surfacing edge lines and between the surfacing edge lines of the correspondence strip in the second mammographic image, the center line dividing the outline line in two sections.

7. The method of claim 6, wherein the correspondence strip has a width between the surfacing edge lines that is equal to a tenth of the length of the baseline of the second mammographic image.

8. The method of claim 1, wherein the place in the first mammographic image is definable by an input device.

9. The method of claim 8, wherein the position of the place in the first mammographic image is changed by using the input device, and the correspondence strip in the second mammographic image of the second orientation view is changed simultaneous in the same manner.

10. The method of claim 1, wherein the correspondence strip is used to assign a suspicious area in the first mammographic image to a corresponding suspicious area in the second mammographic image.

11. The method of claim 10, further comprising markers of suspicious areas all within the correspondence strip of the first mammographic image as possibly corresponding with suspicious areas of the second mammographic image.

12. The method of claim 11, wherein a region around the suspicious areas in the first mammographic image and a region around a suspicious area in the second mammographic image is synchronously increased.

13. An apparatus for displaying digital mammographic images comprising:
means for obtaining at least two mammographic images using at least two different orientation views;
means for displaying a place in a first mammographic image of a first orientation view; and
means for displaying a correspondence strip in a second mammographic image of a second orientation view;
wherein the correspondence strip indicates a range in the second mammographic image of the second orientation view where to locate the place in the second mammographic image of the second orientation view.
